(19) United States
(12) Patent Application Publication
(10) Pub. No.: US 2022/0369675 A1
(43) Pub. Date: Nov. 24, 2022

(54) MICROORGANISM MIXTURE, COMPOSITION, PROCESS FOR THE PREPARATION THEREOF, METHOD AND USE IN TREATING SOLID ORGANIC WASTE

(71) Applicant: Bioconverter Fabricação e Locação de Equipamentos LTDA, Itapevi (BR)

(72) Inventor: Nelson Naim LIBBOS, Sao Paulo (BR)

(21) Appl. No.: 17/724,269

(22) Filed: Apr. 19, 2022

(30) Foreign Application Priority Data
Apr. 20, 2021 (BR) 102021007577-5

(51) Int. Cl. A23L 3/3571; A23L 3/32; C02F 3/34; A23L 29/00

(52) U.S. Cl. CPC A23L 3/3571; A23L 3/32; C02F 3/348; A23L 29/065

(57) ABSTRACT

The present invention relates to a microorganism mixture comprising one or more microorganisms selected from the Bacillus, Paenibacillus, lactobacillus, Pseudomonas, Trichoderma, aspergillus, and Saccharomyces genera, and which is useful in treating of solid organic waste. The present invention also relates to a composition comprising said microorganism mixture, a process for preparing said composition, a method for treating solid organic waste, and the use of the microorganism mixture or the composition of the invention in treating solid organic waste.

### CROSS REFERENCE TO RELATED APPLICATION

This application claims priority to Brazilian Patent Application 102021007577-5, filed Apr. 20, 2021, the content of which is hereby incorporated by reference in its entirety.

### TECHNICAL FIELD

The present invention relates to treating solid organic waste, particularly food waste.

More specifically, the present invention relates to microorganism mixtures, as well as compositions comprising said mixtures, which can be used for treating solid organic waste, promoting the accelerated digestion of said waste by means of an aerobic process.

### BACKGROUND OF THE INVENTION

The volume of solid waste produced worldwide has increased with population growth. According to the United Nations, around 354 thousand tons of municipal solid waste are generated every day in Latin America, whereby 50% or more are composed of food waste and materials of organic origin (Organic Waste Management in Latin America: Challenges and Advantages of the Main Treatment Options and Trends. 2017. Available at: <https://abrelpe.org.br/onu-mein-ambiente-ingles/>. Accessed on Apr. 16, 2021). In Brazil, 79 million tons of urban solid waste were generated in 2018, according to the Brazilian Association of Public Cleaning Companies (Ministry of the Environment. Consulta Pública do Plano Nacional de Residuos Sólidos. Brasilia: MMA, 2020. Available at: <http://consultaspublicas.mma.gov.br/planares/>. Accessed on Apr. 16, 2021).

The large volume of urban solid waste produced in Brazil and in the world generates great challenges with regard to their transportation and proper management, with impacts on population health and well-being, as well as on the environment.

A large part of the urban solid waste produced worldwide, especially organic waste, is sent to sanitary landfills and dumps, with different impacts, such as the generation of greenhouse gases, the treatment of which requires additional actions and costs. Due to the volume and impacts of urban organic waste, efficient and easy-to-apply treatments need to be developed in order to minimize costs and consequences for the environment and health.

In recent decades, technologies have emerged aimed at treating solid organic waste, such as composting and anaerobic digestion (or biodigestion). However, each of these technologies has its drawbacks.

Organic materials are decomposed in composting in order to obtain a stable material, rich in humic substances and mineral nutrients, thus forming a moist soil. The composting process typically produces a considerable volume of solid material (Amazonian dark earth) which, although useful, makes using the process impractical in urban establishments.

Biodigestion is a process of producing fuel gas and organic fertilizer from organic materials. The process is normally performed in biodigesters and requires control of the reactions occurring within the system. A two or more stage digestion system is often employed, in which different digestion vessels are optimized to provide maximum control over the bacterial communities living inside digesters. It may also have a pasteurization or sterilization stage before digestion or between the two digestion tanks. Biodigestion is a complex process which requires a higher degree of investment and control. Furthermore, although the methane produced is useful, its production makes using the process impractical in urban establishments, as it is necessary to purify and store or distribute the produced gas.

US 2014/0273150 discloses compositions including a microorganism mixture, nutritional components, emulsifiers, and enzymes which provide bioremediation and which are useful in removing, degrading, and/or bioremediating a hydrocarbon from an area. Said document does not pertain to treating solid organic waste.

US 2017/0008814 discloses a biocatalytic composition adapted to transform organic substrates, which is reacted with, in non-polluting organic compounds ready for a subsequent use. Said biocatalytic composition is intended to be used in agricultural, zootechnical and environmental recovery fields, in particular for treating organic waste, settling tanks of municipal or zootechnical wastewater, or water treatment. This document is not specifically concerned with the treatment of solid organic waste.

Turhan, Emel Ünal et al. “Beneficial Biofilm Applications in Food and Agricultural Industry”. Health and Safety Aspects of Food Processing Technologies. Springer, Cham, 2019. 445-469 describes beneficial biofilms from microorganisms which can be used for wastewater treatment and bioremediation. Said document does not pertain to treating solid organic waste.

US 2015/0167022 discloses a method of processing municipal solid waste for producing biomethane. The method described in said document comprises a first step of enzymatic hydrolysis of the biodegradable components of the waste simultaneously with microbial fermentation at a temperature between 45 and 75° C., resulting in the liquefaction of the biodegradable components of the waste and accumulation of microbial metabolites. The bioliquid produced then undergoes anaerobic digestion to produce biomethane.

US 2018/0029947 discloses activated aerobic composting media containing coconut fiber (coir pith) with nutritional alterations and a microbial culture consortium for the biodegradation of organic wastes into an organic fertilizer. Said document further discloses a process for the biodegradation of organic waste resulting in a high-quality organic fertilizer.

There is a need prior art of a technology for efficiently treating solid organic waste which can be easily used in urban establishments.

### SUMMARY OF THE INVENTION

The present invention relates to a microorganism mixture comprising two or more microorganisms selected from the Bacillus, Paenibacillus, lactobacillus, Pseudomonas, Trichoderma, aspergillus, and Saccharomyces genera. In particular, the microorganism mixture comprises two or more microorganisms selected from the Bacillus subtilis, Bacillus licheniformis, Paenibacillus polymyxa, Lactobacillus acidophilus, Pseudomonas putida, Bacillus pumilus, Trichoderma harzianum, Aspergillus brasiliensis, Bacillus megaterium, Lactobacillus plantarum, and Saccharomyces cerevisiae species.

The present invention also discloses a composition comprising said microorganism mixture, as well as a process for preparing said composition.

The invention further relates to a method for treating solid organic waste, as well as the use of the microorganism mixture or the composition of the invention in treating solid organic waste.

### DETAILED DESCRIPTION

The present invention relates to a microorganism mixture comprising two or more microorganisms selected from the Bacillus, Paenibacillus, Lactobacillus, Pseudomonas, Trichoderma, aspergillus, and Saccharomyces genera.

In one embodiment, the microorganism mixture comprises two or more microorganisms selected from the Bacillus subtilis, Bacillus licheniformis, Paenibacillus polymyxa, Lactobacillus acidophilus, Pseudomonas putida, Bacillus pumilus, Trichoderma harzianum, Aspergillus brasiliensis, Bacillus megaterium, Lactobacillus plantarum, and Saccharomyces cerevisiae species.

In one specific embodiment, the microorganism mixture comprises microorganisms from the Bacillus subtilis, Bacillus licheniformis, Paenibacillus polymyxa, Lactobacillus acidophilus, Pseudomonas putida, Bacillus pumilus, and Trichoderma harzianum species.

In another specific embodiment, the microorganism mixture comprises microorganisms from the Bacillus subtilis, Bacillus licheniformis, Paenibacillus polymyxa, Lactobacillus acidophilus, Pseudomonas putida, Bacillus pumilus, and Aspergillus brasiliensis species.

The present invention further relates to a microorganism mixture defined herein for use in treating solid organic waste.

In one embodiment, the solid organic waste is food waste.

In one embodiment, treating solid organic waste consists of accelerated waste digestion, wherein said accelerated digestion is an aerobic process, optionally with controlled aeration.

In one embodiment, treating solid organic waste is performed in equipment equipped with controlled aeration and mixing resources.

The present invention further relates to a composition comprising a microorganism mixture defined herein.

In one embodiment, the composition further comprises one or more ingredients selected from a drier, a preservative, and a dispersant.

In one embodiment, the drier is selected from kaolin, silicon dioxide, diatomaceous earth, bentonite, agalmatolite, calcium carbonate, magnesium carbonate, calcium silicate, autoclaved bone meal. and talc. In one specific embodiment, the drier is kaolin.

In one embodiment, the preservative is selected from NaCl, sodium lactate, potassium lactate, citric acid, algae extract, and silicon dioxide. In one specific embodiment, the preservative is NaCl.

In one embodiment, the dispersant is selected from a cereal bran (including wheat bran, corn bran, and rice bran), carboxymethyl cellulose (CMC), hydroxymethyl cellulose (HMC), bentonite, aluminum silicate, and magnesium silicate. In a specific embodiment, the dispersant is food-grade wheat bran.

In one embodiment, the composition comprises, in % by weight, 31.6% to 33.2%, preferably 32.4%, of dryer, 13% to 17%, preferably 15%, of preservative, and 43% to 45%, preferably 44%, of dispersant.

In one embodiment, the composition comprises:

5×10⁷ CFU/g of Bacillus subtilis;

5×10⁷ CFU/g of Bacillus licheniformis;

4×10⁷ CFU/g of Paenibacillus polymyxa;

3×10⁷ CFU/g of Lactobacillus acidophilus;

3×10⁷ CFU/g of Pseudomonas putida;

3×10⁷ CFU/g of Bacillus pumilus;

3×10⁷ CFU/g of Trichoderma harzianum or Aspergillus brasiliensis.

The present invention further relates to a composition defined herein for use in treating solid organic waste.

In one embodiment, treating solid organic waste consists of accelerated waste digestion, wherein said accelerated digestion is an aerobic process, optionally with controlled aeration.

In one embodiment, treating solid organic waste is performed in equipment equipped with controlled aeration and mixing resources.

The present invention also relates to a process for preparing the composition defined herein, wherein the process comprises the following steps (c) to (g):

(c) adding each microorganism to a culture medium (broth);

(d) preparing the inoculum with the product obtained from step (c);

(e) fermenting the inoculum obtained from step (d);

(f) drying the fermented material obtained in step (e), thus obtaining each dried microorganism active ingredient; and

(g) mixing the dry active ingredients obtained from step (f) and optionally a preservative and/or a dispersant until a homogeneous composition is obtained.

In one embodiment, in step (c) of the process of the present invention, the culture medium comprises 0.2% to 0.4%, preferably 0.3% v/v casein, 0.4% to 0.6%, preferably 0.5% v/v yeast extract, 0.005% v/v manganese sulfate tetrahydrate, 0.005% v/v magnesium sulfate heptahydrate, 0.005% v/v calcium chloride hexahydrate, 0.005% v/v potassium phosphate dibasic, 0.3% to 0, 5% v/v agar (depending on medium's degree of gelation) and distilled water enough for 1 L and pH=7.0±0.2.

In one embodiment, in step (d) of the process of the present invention, inoculum preparation is performed in an incubator chamber with orbital agitation (shaker) according to the following parameters:

rotation from 70 to 90 rpm, preferably from 78 to 82 rpm, more preferably 80 rpm;

incubation temperature from 34 to 38° C., preferably 35.5 to 36.5° C., more preferably 36° C.;

fermentation time from 44 to 54 hours, preferably from 48 to 50 hours, more preferably 49 hours; and

pH from 6.5 to 7.9, preferably from 6.9 to 7.5, more preferably 7.2.

In one embodiment, in step (e) of the process of the present invention, fermentation is performed by transferring each inoculum to an industrial fermentation tank filled with mash and by proceeding with batch fermentation, according to the following parameters:

rotation from 80 rpm to 120 rpm, preferably 95 rpm to 105 rpm, more preferably 100 rpm;

incubation temperature from 34 to 38° C., preferably 35.5 to 36.5° C., more preferably 36° C.;

fermentation time from 161 to 181 hours, preferably from 168 to 174 hours, more preferably 171 hours; and

pH from 6.5 to 7.9, preferably from 6.9 to 7.5, more preferably 7.2.

In one embodiment, the mash comprises 0.24% to 0.32%, preferably 0.28% w/w of brown sugar, 0.1% to 0.3%, preferably 0.2% w/w of plasma, 0.1% to 0.3%, preferably 0.2% w/w of starch, 0.02% to 0.06%, preferably 0.04% w/w of fat (lard), 0.01% to 0.03%, preferably 0.02% w/w of cooking salt, 0.1% to 0.3%, preferably 0.2% w/w of soy protein, 0.01% to 0.01%, preferably 0.02% w/w of calcium chloride, 0.010% to 0.014%, preferably 0.012% w/w of zinc sulfate, 0.006% to 0.010%, preferably 0.008% of ferrous sulfate, 0.002% to 0.006%, preferably 0.004% w/w of cobalt sulfate and filtered and dechlorinated water in sufficient amount to complete the volume of the fermentation tank. In one embodiment, the fermentation tank has a nominal capacity of about 250 L.

In one embodiment, in step (f) of the process of the present invention, drying is performed by contacting a drier selected from kaolin, silicon dioxide, diatomaceous earth, bentonite, agalmatolite, calcium carbonate, magnesium carbonate, silicate of calcium, autoclaved bone meal, and talc. In one specific embodiment, the drier is kaolin. In one specific embodiment, kaolin is used in a ratio of about 21% of fermented material to about 79% of kaolin.

In one embodiment, in step (g) of the process of the present invention, mixing is performed in a Ribbon Blender mixer.

In one embodiment, in step (g) of the process of the present invention, the mixture is made with 40% to 42% of dry active ingredients obtained in step (f), 13 to 17% of preservative and 43% a 45% of dispersant, in % by weight.

In one embodiment, the composition obtained in step (g) comprises, by in % by weight, 31.6% to 33.2%, preferably 32.4% of desiccant, 13% to 17%, preferably 15% of preservative, and 43% to 45%, preferably 44% of dispersant.

In one embodiment, the dispersant is a cereal bran, preferably wheat bran, corn bran, or rice bran, more preferably food-grade wheat bran.

In one embodiment, the process according to the present invention further comprises the following steps (h) to (j):

(h) performing analysis of microorganism concentration in CFU/g of the composition obtained from step (g), assessing if the following parameters are met:

heterotrophic bacteria: 2.0×10⁸ to 3.5×10⁸ CFU/g;

viable spores: 1.0×10⁷ to 2.5×10⁷ CFU/g;

conidia count: about 1.0×10⁷ conidia/g;

(i) performing analysis for pathogenic contaminating microorganisms, such as Escherichia coli, Pseudomonas aeruginosa, salmonella spp., and Staphylococcus aureus in each batch of finished product, in which sampling from each batch of finished product follows the formula \sqrt{N}+1, in which N is the amount of finished product, in kilograms or units, per lot, using a methodology described, for example, in Brazilian Pharmacopoeia, 4^{th} edition, 1998; Brazilian Pharmacopoeia, 5^{th} edition, 2010; United States Pharmacopeia USP 36, 2012; United States Pharmacopeia and National Formulary USP 41-NF 36, 2018; United States Pharmacopeia and National Formulary USP 41-NF 36, Method 62, 2018, Cosmetic, Toiletry, and Fragrance Association (CTFA) Microbiology Guidelines, 2007; CTFA Microbiology Guidelines, Section 19 M-2, 2007, incorporated herein by reference; and

(j) packing the product obtained from step (g), preferably with packing made from virgin plastic.

In one embodiment, the process according to the present invention further comprises the following steps (a) and (b):

(a) performing analysis for pathogenic contaminating microorganisms, such as Escherichia coli, Pseudomonas aeruginosa, salmonella spp., and Staphylococcus aureus in each batch of raw material (dryer, preservative, and dispersant), in which the sampling of each batch of raw material follows the formula \sqrt{N}+1, in which N is the amount of raw material, in kilograms or units, per batch, employing, for example, a methodology described in step (i) above; and

(b) performing moisture analysis on each batch of raw material, verifying that moisture is between about 8% and about 10% by weight,

in which step (b) may be performed by means of oven drying, Thermogravimetry analysis (TGA), Karl Fischer Titration or any other suitable method, preferably by means of oven drying.

The present invention also relates to a composition produced by the process defined herein.

The present invention also relates to a method for treating solid organic waste which comprises contacting said waste with a microorganism mixture or a composition defined herein.

In one embodiment, the solid organic waste is food waste.

In one embodiment, treating solid organic waste consists of accelerated waste digestion, wherein said accelerated digestion is an aerobic process, optionally with controlled aeration.

In one embodiment, treating solid organic waste is performed in equipment equipped with controlled aeration and mixing resources.

The present invention also relates to the use of a microorganism mixture or a composition defined herein in treating solid organic waste.

In one embodiment, the solid organic waste is food waste.

In one embodiment, treating solid organic waste consists of accelerated waste digestion, wherein said accelerated digestion is an aerobic process, optionally with controlled aeration.

In one embodiment, treating solid organic waste is performed in equipment equipped with controlled aeration and mixing resources.

Treating solid organic waste according to the present invention provides a total reduction in the volume of solid organic waste, converting said waste into nutrient-rich gray water, which can be recycled or safely disposed of in sewage systems.

The microorganism mixture according to the present invention enhances the naturally occurring process of aerobic digestion of organic waste, causing digestion to occur in an accelerated manner.

The microorganism mixture of the invention is capable of treating most typical solid organic waste, particularly food waste, within 24 hours or less. In addition, waste treatment can be performed at the same site in which it is produced, using appropriate equipment, providing savings when compared to currently existing processes in relation to the storage, collection, transport and disposal of waste in sanitary landfills, in addition to being an environmentally friendly solution.

The present invention can be used in several places in which solid organic waste is generated, such as restaurants and bars, industrial restaurants, supermarkets, shopping centers, industries, hospitals, schools and universities, clubs and associations, residences, residential complexes, maritime vessels and rivers, or any place in which solid organic waste is generated, especially food waste.

It is worth noting that, in the currently existing processes, solid organic waste is collected, transported, and sent to landfills, which is harmful to the environment, as these processes (i) generate greenhouse gases, (ii) are anaerobic processes generating odors, (iii) are slow decomposition processes, allowing the attraction and propagation of disease vectors (insects, rodents, etc.), as well as proliferation of pathogenic microorganisms.

The microorganism mixture according to the present invention provides economic and environmental advantages, thus overcoming the inconveniences of currently existing processes through accelerated aerobic digestion.

As can be seen, the present invention overcomes the disadvantages and drawbacks of the state of the art. It is worth noting that the following examples should not be considered as limiting of the present invention, since one skilled in the art is fully capable of understanding that modifications can be made within the scope of the invention.

The entire contents of all references (patent or non-patent) cited throughout this application are hereby incorporated by reference, in particular for the teaching of the invention disclosed herein.

### EXAMPLES

The examples presented herein are non-exhaustive, serving only to illustrate the invention and should not be used as limiting.

### Comparative Example 1

In comparative field tests performed with products available on the market intended to degrade organic matter, such as Enzmax (Klasta Tecnologia Ambiental Ltda), Enzilimp (Millenium Tecnologia Ambiental Ltda.) and Biotrat (RZK Quimica do Brasil Ltda.), the microorganism mixture according to the present invention demonstrated a superior performance in biodegradation of food residues having diverse compositions (varying in carbohydrate, protein, lipid, and fiber contents) with a biodegradation rate such that the entire waste digestion process was performed in less than 24 hours, as well as stable biofilm forming ability and superior sporulation and recolonization ability, delivering longer lasting performance.

### Example 1: Composition Preparation

Each of the following microorganisms was added to an Erlenmeyer flask filled with culture medium: Bacillus subtilis, Bacillus licheniformis, Paenibacillus polymyxa, Lactobacillus acidophilus, Pseudomonas putida, Bacillus pumilus, and Aspergillus brasiliensis, in which the culture medium consisted of 0.3% v/v of casein, 0.5% v/v of yeast extract, 0.005% v/v of manganese sulfate tetrahydrate, 0.005% v/v of sodium sulfate magnesium heptahydrate, 0.005% v/v of calcium chloride hexahydrate, 0.005% v/v of dibasic potassium phosphate, 0.4% of agar and enough distilled water for 1 L and pH=7.0.

The vials were transferred to a shaker and the preparation of the inoculum proceeded according to the following parameters:

rotation: 80 rpm;

incubation temperature: 36° C.;

fermentation time: 49 hours; and

pH: 7.2.

The final counting of microorganisms obtained in each inoculum was 2.0×10⁹ CFU/mL. Microorganisms were counted using microbiological sample preparation procedures, seeding techniques and serial decimal dilution counting methodology, based on the Brazilian Pharmacopoeia, 5^{th} edition, 2010.

Each inoculum was then transferred to a 250 L nominal capacity industrial fermentation tank filled with mash, in which the mash consisted of 0.28% w/w of brown sugar, 0.2% w/w of plasma, 0.2% w/w of starch, 0.04% w/w of fat (lard), 0.2% w/w of table salt, 0.02% w/w of soy protein, 0.02% w/w of calcium chloride, 0.012% w/w of zinc sulfate, 0.008% w/w of ferrous sulfate, 0.004% of cobalt sulfate, and filtered and dechlorinated water in an amount sufficient to complete the volume of the fermentation tank. Then the fermentation proceeded in batches, according to the following parameters:

rotation: 100 rpm;

incubation temperature: 36° C.;

fermentation time: 171 hours; and

pH: 7.2.

The final counting of microorganisms obtained in the fermentation step was 3.5×10¹⁰ CFU/mL.

Each fermented material was then dried by contact with kaolin, thus obtaining each dry microorganism active ingredient.

The obtained dry active ingredients were mixed with 15% by weight of NaCl and 44% by weight of food-grade wheat bran in a Ribbon Blender mixer until a homogeneous composition was obtained, in which the percentages by weight are in relation to the total weight of the composition.

### Example 2: Food Waste Treatment

The microorganism mixture obtained according to Example 1 was tested in equipment capable of controlling aeration, humidity, and temperature conditions, treating various food wastes having variable composition, containing 50% to 60% of carbohydrates, 15% 20% of proteins, 20 to 30% of lipids and 2% to 15% of fibers, using 0.1% to 0.4%, in % by weight, of the microorganism mixture.

In every case, the food waste digestion process began immediately after the equipment's environment was properly colonized and biofilms were created on walls and media by the microorganisms contained in the formulation. An efficient and accelerated food waste digestion was observed in less than 24 hours with a reduction in the volume of organic matter above 99.5%, which was converted into gray water.

What is claimed is:

1. A microorganism mixture comprising two or more microorganisms selected from the group consisting of Bacillus, Paenibacillus, lactobacillus, Pseudomonas, Trichoderma, aspergillus, and Saccharomyces genera.

2. The microorganism mixture according to claim 1, comprising two or more microorganisms selected from the group consisting of Bacillus subtilis, Bacillus licheniformis, Paenibacillus polymyxa, Lactobacillus acidophilus, Pseudomonas putida, Bacillus pumilus, Trichoderma harzianum, Aspergillus brasiliensis, Bacillus megaterium, Lactobacillus plantarum, and Saccharomyces cerevisiae species.

3. The microorganism mixture according to claim 1, comprising microorganisms of Bacillus subtilis, Bacillus licheniformis, Paenibacillus polymyxa, Lactobacillus acidophilus, Pseudomonas putida, Bacillus pumilus, and Trichoderma harzianum species.

4. The microorganism mixture according to claim 1, comprising microorganisms of Bacillus subtilis, Bacillus licheniformis, Paenibacillus polymyxa, Lactobacillus acidophilus, Pseudomonas putida, Bacillus pumilus, and Aspergillus brasiliensis species.

5. The microorganism mixture according to claim 1, characterized in that it is for use in treating solid organic waste.

6. A composition comprising the microorganism mixture.

7. The composition according to claim 6, further comprising one or more ingredients selected from the group consisting of a drier, a preservative, and a dispersant.

8. The composition according to claim 7, wherein the drier is selected from the group consisting of kaolin, silicon dioxide, diatomaceous earth, bentonite, agalmatolite, calcium carbonate, magnesium carbonate, calcium silicate, autoclaved bone meal, and talc.

9. The composition according to claim 7, wherein the preservative is selected from the group consisting of NaCl, sodium lactate, potassium lactate, citric acid, seaweed extract, and silicon dioxide.

10. The composition according to claim 7, wherein the dispersant is selected from the group consisting of a cereal bran, carboxymethyl cellulose (CMC), hydroxymethyl cellulose (HMC), bentonite, aluminum silicate, and magnesium silicate.

11. The composition according to claim 6, comprising:
5×10⁷ CFU/g of Bacillus subtilis;
5×10⁷ CFU/g of Bacillus licheniformis;
4×10⁷ CFU/g of Paenibacillus polymyxa;
3×10⁷ CFU/g of Lactobacillus acidophilus;
3×10⁷ CFU/g of Pseudomonas putida;
3×10⁷ CFU/g of Bacillus pumilus; and
3×10⁷ CFU/g of Trichoderma harzianum or Aspergillus brasiliensis.

12. The composition according to claim 6, intended for use in treating solid organic waste.

13. A process for preparing the composition according to claim 6, comprising the following steps (c) to (g):
(c) adding each microorganism to a culture medium (broth);
(d) preparing the inoculum with the product obtained from step (c);
(e) fermenting the inoculum obtained from step (d);
(f) drying the fermented material obtained from step (e), thus obtaining each dried microorganism active ingredient; and
(g) mixing the dry active ingredients obtained from step (f) and optionally a preservative and/or a dispersant until a homogeneous composition is obtained.

14. The process according to claim 13, wherein:
i) in step (d), inoculum preparation is performed in an incubator chamber with orbital agitation (shaker) according to the following parameters:
rotation from 70 to 90 rpm, preferably from 78 to 82 rpm, more preferably 80 rpm;
incubation temperature from 34 to 38° C., preferably 35.5 to 36.5° C., more preferably 36° C.;
fermentation time from 44 to 54 hours, preferably from 48 to 50 hours, more preferably 49 hours; and
pH from 6.5 to 7.9, preferably from 6.9 to 7.5, more preferably 7.2;
ii) in step (e), fermentation is performed by transferring each inoculum to an industrial fermentation tank filled with mash and by proceeding with batch fermentation, according to the following parameters:
rotation from 80 rpm to 120 rpm, preferably 95 rpm to 105 rpm, more preferably 100 rpm;
incubation temperature from 34 to 38° C., preferably 35.5 to 36.5° C., more preferably 36° C.;
fermentation time from 161 to 181 hours, preferably from 168 to 174 hours, more preferably 171 hours; and
pH from 6.5 to 7.9, preferably from 6.9 to 7.5, more preferably 7.2;
iii) in step (f), drying is performed by contact with a drier; and/or
iv) in step (g), mixing is performed in a Ribbon Blender mixer.

15. The process according to claim 13, further comprising the following steps (h) to (j):
(h) performing analysis of microorganism concentration in CFU/g of the composition obtained from step (g), assessing if the following parameters are met:
heterotrophic bacteria: 2.0×10⁸ to 3.5×10⁸ CFU/g;
viable spores: 1.0×10⁷ to 2.5×10⁷ CFU/g; and
conidia count: about 1.0×10⁷ conidia/g;
(i) performing analysis for pathogenic contaminating microorganisms, such as Escherichia coli, Pseudomonas aeruginosa, salmonella spp., and Staphylococcus aureus in each batch of finished product, wherein sampling from each batch of finished product follows the formula \sqrt{N}+1, wherein N is the amount of finished product, in kilograms or units, per batch; and
(j) packing the product obtained from step (g), preferably with packing made from virgin plastic.

16. The process according to claim 13, further comprising the following steps (a) and (b):
(a) performing analysis for pathogenic contaminating microorganisms, such as Escherichia coli, Pseudomonas aeruginosa, salmonella spp., and Staphylococcus aureus in each batch of raw material (dryer, preservative, and dispersant); and
(b) performing moisture analysis on each batch of raw material, wherein step (b) is preferably performed by means of oven drying, Thermogravimetric analysis (TGA) or Karl Fischer Titration.

17. (canceled)

18. A method for treating solid organic waste, comprising placing said waste in contact with the microorganism mixture according to claim 1 or the composition according to claim 6.

19. (canceled)

20. The method according to claim 18, wherein the solid organic waste is food waste.

21. The method according to claim 18, further comprising allowing accelerated digestion of the solid organic waste, wherein said accelerated digestion is an aerobic process.

22. The method according to claim 18, wherein placing said waste is performed in an equipment equipped with controlled aeration and mixing resources.

23. (canceled)
